(19) United States
(12) Patent Application Publication
(10) Pub. No.: US 2016/0108584 A1
(43) Pub. Date: Apr. 21, 2016

(54) ARTIFICIAL TURF STRUCTURE AND APPARATUS AND METHOD FOR MANUFACTURING THE SAME

(71) Applicant: KOLON GLOTECH, INC., Gwacheon (KR)

(72) Inventors: Jung Hun KIM, Busan (KR); Young Hoon KWON, Gumi (KR); Jong Pil KIM, Daegu (KR)

(21) Appl. No.: 14/981,532

(22) Filed: Dec. 28, 2015

Related U.S. Application Data
(62) Division of application No. 13/805,685, filed on Dec. 20, 2012.

(30) Foreign Application Priority Data
May 31, 2011 (KR) 10-2011-0051900
May 31, 2011 (KR) 10-2011-0051901
May 31, 2012 (KR) 10-2012-0057920

(51) Int. Cl. E01C 13/08; D05C 17/02; B32B 5/26; D03D 27/12

(52) U.S. Cl. CPC E01C 13/08; D03D 27/12; D05C 17/02; B32B 5/26; B32B 2262/0253

(57) ABSTRACT

An artificial turf structure, an apparatus, a method for manufacturing the same are provided. In accordance of the present invention, the apparatus for manufacturing the artificial turf structure includes a backing fabric providing unit for providing a first backing fabric and a second backing fabric forming a first structure, a weaving unit for weaving a second structure in which a part of pile yarns are exposed under the first structure by tufting the pile yarns to upper parts of the first structure, and a heat-fusing unit for compressing the second structure using tension and heat-fusing the pile yarns exposed under the second structure using heat.

### CROSS REFERENCE TO RELATED APPLICATIONS AND CLAIM OF PRIORITY

This patent application claims benefit under 35 U.S.C. 119(e), 120, 121, or 365(c), and is a National Stage entry from International Application No. PCT/KR2012/004289, filed on May 31, 2012, which claims priority to Korean Patent Application Nos. 10-2011-0051900, filed May 31, 2011, 10-2011-0051901, filed May 31, 2011, and 10-2012-0057920, filed May 31, 2012, entire contents of which are incorporated herein by reference.

### BACKGROUND OF THE INVENTION

1. Field of the Invention

The present invention relates to an artificial turf structure, an apparatus, and a method for manufacturing the same.

2. Description of the Related Art

Usually, artificial turfs are made of synthetic fibers. The artificial turfs have numerous advantages such as easy management after construction and maintaining green over natural turfs for outdoor sports use. For this reason, they have been widely used in the field of soccer field, hockey field, interior for building, and leisure facilities.

The artificial turfs include a backing fabric layer formed of woven fabric or non-woven fabric of synthetic fibers, a pile layer in which pile yarns are tufted to be formed on upper parts of the backing fabric layer, and a supporting layer formed under the backing fabric layer.

Also, the supporting layer performs a function to prevent the pile yarns of the pile layer from being pulled out and to keep the shape of the artificial turfs maintained. The supporting layer is formed by coating acryl resin latex, polyurethane resin latex, or styrene-butadiene (SBR) and drying.

In the meanwhile, in a conventional method for manufacturing an artificial turf, a weaving process for forming the pile layer on the backing fabric layer using a weaving apparatus and a process for forming the supporting layer under the backing fabric layer where the pile layer is formed using additional processing apparatus. Accordingly, there are problems in that manufacturing time is increased, excessive labors are required, and labor efficiency of process for manufacturing the artificial turfs.

In addition, the backing fabric layer and the pile layer have the same material as synthetic fiber with similar property. The supporting layer is formed of latex, which has different property in comparison with the backing fabric layer and the pile layer. Resultantly, complex recycling process is necessary so as to recycle artificial turf over usage period, or the artificial turf cannot be recycled.

Moreover, since the supporting layer is formed of different material as compared to the backing fabric layer and the pile layer, the adhesion of the supporting layer is deteriorated not to strongly fix the pile yarns of the pile layer when the artificial turf is used for a long time, and the durability of the artificial turf becomes reduced.

### SUMMARY

It is, accordingly, an object of the present invention to provide an artificial turf structure and a method for manufacturing the same in which artificial turfs can be easily recycled because artificial turfs being complete products are only formed of synthetic fabrics, and pile yarns of artificial turfs are solidly fixed without additional latex coating process, and the appearance of artificial turfs becomes stabilized.

It is another object of the present invention to provide an artificial turf structure and a method for manufacturing the same in which synthetic artificial turfs can be manufactured to recycle all entire artificial turfs over use period without using latex.

It is still another object of the present invention to provide an artificial turf structure and a method for manufacturing the same in which pile yarns of artificial turfs can be solidly fixed, and the appearance of the artificial turfs can be maintained.

It is still another object of the present invention to provide an artificial turf structure and a method for manufacturing the same capable of simplifying a manufacturing process of artificial turfs.

Embodiments of the present invention provide an apparatus for manufacturing artificial turf structure including a backing fabric providing unit for providing a first backing fabric and a second backing fabric forming a first structure, a weaving unit for weaving a second structure in which a part of pile yarns are exposed under the first structure by tufting the pile yarns to upper parts of the first structure, and a heat-fusing unit for compressing the second structure using tension and heat-fusing the pile yarns exposed under the second structure using heat.

In some embodiments of the present invention, the heat-fusing unit includes a heating roller for applying heat to the pile yarns, and a tension roller isolated from the heating roller at a predetermined distance and generating tension to compress the second structure and the pile yarns heated by the heating roller.

In some embodiments of the present invention, the heating roller is coated with TEFLON or epoxy resins.

In some embodiments of the present invention, the heating roller is heated at a temperature of 140° C. to 180° C.

In some embodiments of the present invention, a plurality of heat-fusing units is included.

In some embodiments of the present invention, the weaving unit further includes a compressing roller forming the first structure by compressing the first and second backing fabrics.

In some embodiments of the present invention, the second backing material and the pile yarn are formed of the same material as polyolefin.

In some embodiments of the present invention, the first backing fabric is formed of polyolefin.

Embodiments of the present invention provide a method of manufacturing an artificial turf structure includes providing a first structure formed by overlapping a first backing fabric and a second fabric under the first backing fabric, forming a second structure in which artificial pile yarns are formed to upper parts of the first structure by tufting pile yarns to penetrate the first structure and a part of the pile yarns penetrating into the first structure is exposed, and compressing the second structure using tension and heat-fusing the exposed pile yarns under the second structure using heat.

In some embodiments of the present invention, the first backing fabric is formed of polyolefin.

In some embodiments of the present invention, the second backing fabric and the pile yarns are formed of the same material as polyolefin.

In some embodiments of the present invention, the heat-fusing is performed by applying heat of 140° C. to 180° C. to the second backing fabric and the pile yarn under the second structure.

In some embodiments of the present invention, forming the first structure by compressing the first and second backing fabrics at a predetermined pressure is further included.

In some embodiments of the present invention, the above-mentioned objects can be accomplished according to the method for manufacturing the artificial turf of the present invention.

Embodiments of the present invention provide an artificial turf structure including a structure including a first backing fabric and a second backing fabric, and pile yarns tufted to upper parts of the structure to be partly exposed under the structure, wherein the pile yarns are compressed into the structure and a part of the exposed pile yarns are heat-fused.

In some embodiments of the present invention, the pile yarns are heat-fused to the structure at a temperature of 140° C. to 180° C.

In some embodiments of the present invention, the second backing fabric and the pile yarns are formed of the same material as polyolefin.

In some embodiments of the present invention, the first backing fabric is formed of polypropylene.

Embodiments of the present invention provide an apparatus for manufacturing artificial turf structure including, a weaving unit for weaving a structure in which a part of pile yarns are exposed under a backing fabric by penetrating the backing fabric to tuft the pile yarns, a film providing unit for providing a film toward a back side of the structure, and a heat-fusing unit for compressing the structure and the film using tension and heat-fusing the film under the structure and the structure using heat.

In some embodiments of the present invention, the heat-fusing unit includes a heating roller for applying heat to the film, and a tension roller isolated from the heating roller at a predetermined distance and generating tension to compress the structure and the film heated by the heating roller.

In some embodiments of the present invention, the heating roller is coated with TEFLON or epoxy resins.

In some embodiments of the present invention, a melting unit disposed at a front end of the heat-fusing unit and melts a back side of the structure is further included.

In some embodiments of the present invention, a stabilizing unit for stabilizing the structure and the film heat-fused to the structure using heat is further included.

In some embodiments of the present invention, the film and pile yarns of the structure are formed of the same material as polyolefin.

In some embodiments of the present invention, the melting unit and the stabilizing unit have the same structure as the heat-fusing unit.

In some embodiments of the present invention, a plurality of film providing units is included.

In some embodiments of the present invention, the film providing unit includes a film roller in which the films are rolled, and a guide roller for guiding the films toward the heat-fusing unit.

Embodiments of the present invention provide an artificial turf structure includes, weaving a structure in which a part of pile yarns are exposed under a backing fabric by penetrating the backing fabric to turf the pile yarns, providing a film toward a back side of the structure, and applying tension to compress the film into the back side of the structure and heat-fusing the film under the structure and the structure.

In some embodiments of the present invention, the pile yarns and the film are formed of the same material as polyolefin.

In some embodiments of the present invention, melting the back side of the structure using heat is further included.

In some embodiments of the present invention, stabilizing the structure and the film heat-fused into the structure using heat is further included.

In some embodiments of the present invention, the above-mentioned objects can be accomplished by an artificial turf manufactured according to the method for manufacturing the artificial turf of the present invention.

Embodiments of the present invention provide an artificial turf structure including a structure in which pile yarns partly exposed under a backing fabric by penetrating the backing fabric to tuft the pile yarns, and a film disposed under the structure to fix the structure, wherein the film is compressed into the structure by tension and heat-fused to the structure by heat.

In some embodiments of the present invention, the pile yarns and the film are formed of the same material as polyolefin.

In some embodiments of the present invention, the film is formed of at least one selected from the group consisting of HDPE (High Density Polyethylene), LDPE (Low Density Polyethylene), and LLDPE (Liner Low Density Polyethylene).

In some embodiments of the present invention, the thickness of the film is within a range of 80 μm to 500 μm.

In some embodiments of the present invention, the film further includes a shrinkage prevention agent.

### BRIEF DESCRIPTION OF THE DRAWINGS

FIG. 1 is a schematic view showing an apparatus for manufacturing an artificial turf structure in accordance with an embodiment of the present invention.

FIG. 2 is a flowchart illustrating a method for manufacturing an artificial turf structure in accordance with an embodiment of the present invention.

FIG. 3 shows pile yarns and backing fabrics not heat-fused to an artificial turf structure in accordance with an embodiment of the present invention.

FIG. 4 is a cross-sectional view showing an artificial turf structure in accordance with an embodiment of the present invention.

FIG. 5 is a schematic view showing an apparatus for manufacturing an artificial turf structure in accordance with another embodiment of the present invention.

FIG. 6 is a schematic view showing the apparatus for manufacturing the artificial turf structure of FIG. 5 including a melting unit and a stabilizing unit.

FIG. 7 is a flowchart illustrating a method for manufacturing an artificial turf structure in accordance with another embodiment of the present invention.

FIG. 8 is shows pile yarns, backing fabrics, and films which are not heat-fused to an artificial turf structure in accordance with another embodiment of the present invention.

FIG. 9 is a cross-sectional view showing an artificial turf structure in accordance with another embodiment of the present invention.

FIG. 10 is a bottom perspective view showing a backing side of an artificial turf structure in accordance with another embodiment of the present invention.

### DETAILED DESCRIPTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention. Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

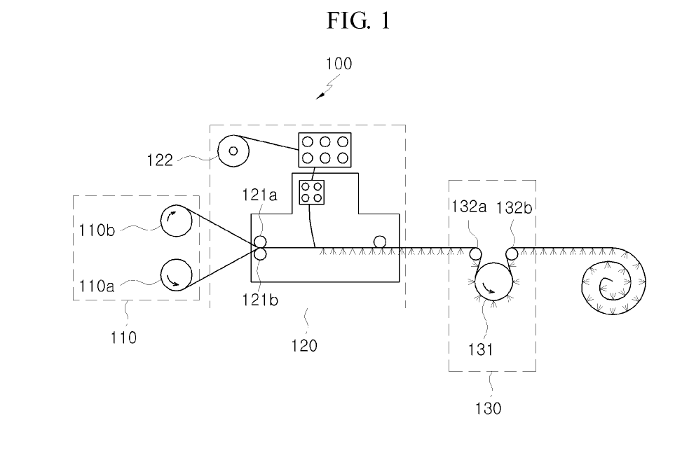

FIG. 1 is a schematic view showing an apparatus 100 for manufacturing an artificial turf structure in accordance with an embodiment of the present invention.

Referring to FIG. 1, the apparatus 100 for manufacturing the artificial turf structure performs a function to manufacture an artificial turf structure formed of synthetic fabric. The tensile strength and appearance stability of the artificial turf structure are improved without coating latex. The manufacturing process of the artificial turf structure can be simplified. Also, the artificial turf structure is manufactured by tufting pile yarns to a plurality of backing fabrics in an embodiment of the present invention. In this case, the plurality of backing fabrics includes a first backing fabric and a second backing fabric.

Additionally, the first backing fabric is formed of polypropylene, and the second backing fabric is formed of polyolefin. In an embodiment of the present invention, the second backing fabric is formed of polyethylene.

The first and second backing fabrics are formed of woven fabric made of polyolefin or non-woven fabric of polyolefin, or polyester staple fiber web or polyolefin staple fiber web may be formed under the woven fabric or non-woven fabric.

The pile yarns are formed of polyolefin which is the same as the material of the second backing fabric and heat-fused to the second backing fabric through a heat-fusing unit described later.

The apparatus of the artificial turf structure 100 according to an embodiment of the present invention includes a backing fabric providing unit 110, a weaving unit 120, and a heat-fusing unit 130. The first and second backing fabrics are heat-fused after tufting the pile yarns.

The backing fabric providing unit 110 provides the first backing fabric and the second backing fabric, and may include a winding roller in which the backing fabrics are wound. The backing fabric providing unit 110 includes a first backing fabric providing unit 110a and a second backing fabric providing unit 110b.

The first backing fabric providing unit 110a includes the first backing fabric which is wound and provides the first backing fabric to the weaving unit 120 described later.

The second backing fabric providing unit 110b includes the second backing fabric which is wound and provides the second backing fabric to the weaving unit 120 described later. Also, the second backing fabric providing unit 110b provides the second backing fabric toward upper parts of the first backing fabric.

The first and second backing fabrics are compressed between compressing rollers 121a and 121b, which are described later, to be formed as a first structure.

The weaving unit 120 performs a function to form a second structure in which the pile yarns are tufted. The weaving unit 120 forms the first structure by compressing the first and second backing fabrics. Then, the second structure is formed by tufting the pile yarns to upper parts of the first structure.

In forming the second structure, the weaving unit 120 is provided in order that the pile yarns penetrate the first structure to tuft it. In this case, artificial pile formed of the pile yarns are formed on upper parts of the second structure. A part of the pile yarns penetrating the first structure is exposed under the second structure.

The weaving unit 120 may be various weaving apparatus capable of tufting fiber yarns on fabrics or backing fabrics.

In addition, the weaving unit 120 may be another weaving apparatus in which the pile yarns are piled in a moquette way or laschel way.

In an embodiment of the present invention, the weaving unit 120 includes the compressing rollers 121a and 121b to form the first structure by compressing the first and second backing fabrics. The compressing rollers 121a and 121b have rollers, which are engaged up and down. The first and second backing fabrics pass between the compressing rollers 121a and 121b to be compressed.

The weaving unit 120 receives the pile yarns from a winding roller 122 in which the pile yarns are wound. The winding roller 122 in which various yarns and pile yarns are wound may be included.

The heat-fusing unit 130 heat-fuses a back side of the second structure. In more detail, the heat-fusing unit 130 heat-fuses the pile yarns exposed under the second structure using heat. At this time, the heat-fusing unit 130 compresses the second structure using tension in order that the pile yarns are fused efficiently.

The pile yarns heat-fused in the heat-fusing unit 130 and the second backing fabric under the second structure are formed of the same material as polyolefin, so that they are melted and heat-fused efficiently. Accordingly, the tensile strength and durability of the pile yarns become enhanced.

A plurality of the heat-fusing units 130 may be included. In this case, the heat-fusing unit is positioned at a front end or a rear end of the weaving unit 120, or the plurality of the heat-fusing units 130 is positioned at the rear end of the weaving unit 120.

The heat-fusing unit 130 according to an embodiment of the present invention includes a heating roller 131 and tension rollers 132a and 132b to apply heat and tension to the second structure and the pile yarns.

The heating roller 131 applies heat to the pile yarns. The heating roller 131 with rollers heated at a predetermined temperature may be included. The pile yarns are in contact with the circumference of the heating roller 131 to be heated.

The circumference of the heating roller 131 is coated with non-adhesive material including polytetrafluoroethylene (TEFLON) or epoxy resins in order that the pile yarns are not fused or adhered.

The heating roller can be heated at a temperature of 140° C. to 180° C. The reason for this is that the first backing fabric of the second structure is formed of polypropylene and the second backing fabric is formed of polyethylene, and the melting point of polypropylene and polyethylene are around 165° C. and 120° C., respectively, so that the first backing fabric is not melted, and only the second backing fabric and the pile yarns are melted and heat-fused. If temperature is lower than the above-mentioned temperature, the tensile strength becomes low so that the pile yarns are insufficiently melted. If temperature is higher than the above-mentioned temperature, the tensile strength is also low so that there may be side effects such that the pile yarns may be shrunk and the artificial turf structure may be shrunk in itself due to high temperature.

The tension rollers 132a and 132b compress the pile yarns and the second structure. A plurality of the tension rollers is included. The cylindrical column of the tension rollers 132a and 132b is smaller than that of the heating roller 131 to be isolated from the heating roller 131 at a predetermined distance and to generate tension to the structure and the film passing the heating roller 131 and the tension rollers 132a and 132b to compress them.

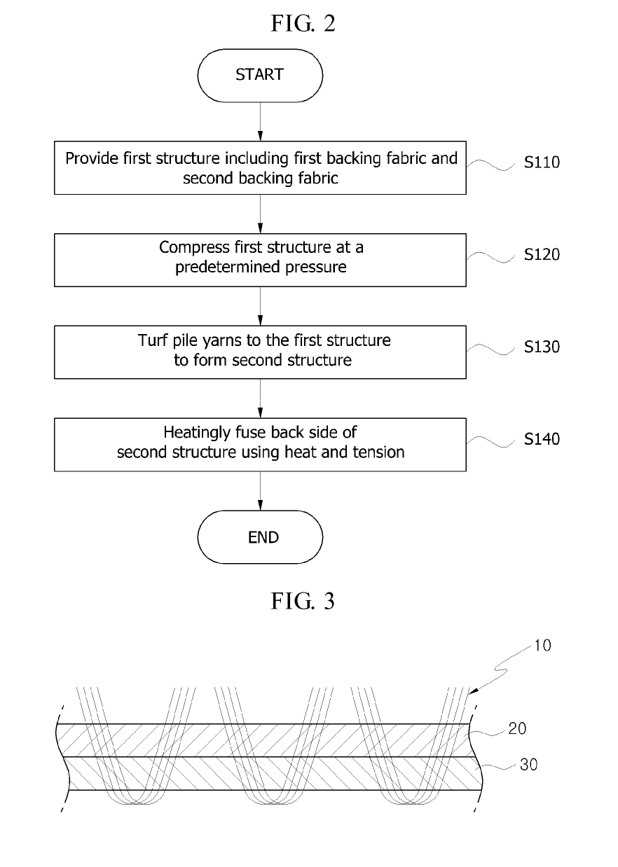

FIG. 2 is a flowchart illustrating a method for manufacturing an artificial turf structure in accordance with an embodiment of the present invention.

Referring to FIG. 2, in the method for manufacturing the artificial turf structure according to an embodiment of the present invention, a first structure is provided in advance. The first structure is formed by overlapping a first backing fabric and a second backing fabric. The first and second backing fabrics may be provided through the backing fabric providing units 110a and 110b.

The first backing fabric is formed of polypropylene, and the second backing fabric is formed of polyolefin. For example, the second backing fabric may be formed of polyethylene, polypropylene, or poly-isobutylene. In an embodiment of the present invention, the second backing fabric is formed of polyethylene.

In this case, the second backing fabric performs a function as a supporting layer of a conventional artificial turf. A conventional supporting layer fixes pile yarns of artificial turfs and stabilizes the appearance of artificial turf (S110).

Next, the first structure is compressed by applying a predetermined pressure. At this time, the first structure may be compressed by passing it between the compressing rollers 121a and 121b, which are engaged up and down.

Also, since additional adhesive agent is not formed between the first and second backing fabrics of the first structure, they are safely adhered by compressing (S120).

Next, the second structure is formed by tufting the pile yarns to penetrate the first structure. In the second structure, the pile yarns form artificial piles toward upper parts.

In tufting the pile yarns, the pile yarns can be tufted to the first structure using the weaving unit 120. At this time, the pile yarns can be piled in moquette way or laschel way. Various weaving apparatus can be employed.

The pile yarns are formed of polyolefin same as the second backing fabric. Also, the pile yarns rolled with the winding roller 12 can be provided.

A part of the pile yarns is exposed under the second structure in which the pile yarns are tufted. The exposed pile yarns are melted to be heat-fused in a heat-fusing process described later.

Next, the back side of the second structure is heat-fused. At this time, the second structure is heat-fused using the heating roller 131 generating heat. In particularly, the second backing fabric forming the second structure is in contact with the circumference of the heating roller 131 to be heat-fused.

The second backing fabric is heat-fused with the pile yarns. The pile yarns penetrating the second structure to be exposed under the second structure is heat-fused with the second backing fabric. Also, the second backing fabric and the pile yarns have the same material as polyolefin to be heat-fused easily. The tensile strength and durability of them become more improved.

The first backing fabric forming the second structure is formed of polypropylene, and the second backing fabric is formed of polyethylene. Since the melting point of polypropylene and polyethylene are around 165° C. and 120° C., respectively, it is preferable that heat-fusing is performed at a temperature between 140° C. and 180° C. so as to enhance tensile strength of the first backing fabric and not to melt the first backing fabric.

In other words, only the second backing fabric and the pile yarns are melted to be heat-fused.

Also, it is preferable that the heating roller 131 is coated with non-adhesive material in order that the second backing fabric or the pile yarns are not heat-fused or adhered to the circumference of the heating roller 131. In an embodiment of the present invention, the non-adhesive material is polytetrafluoroethylene (TEFLON) or epoxy resins, which are coated with the circumference of the heating roller 131.

To heat-fuse the second backing fabric and the pile yarns efficiently, the second structure is compressed using the tension rollers 132a and 132b. In an embodiment of the present invention, the plurality of the tension rollers 132a and 132b is included. The cylindrical column of the tension rollers 132a and 132b is smaller than that of the heating roller 131 and isolated from the heating roller 131 at a predetermined distance. As a result, tension is generated to the second structure passing between the heating roller 131 and the tension rollers 132a and 132b to compress the second structure.

In the meanwhile, after heat-fusing the back side of the second structure, a thermal process is further performed to stabilize the second structure. In this case, the heating roller 131 and the tension rollers 132a and 132b may be employed as mentioned above.

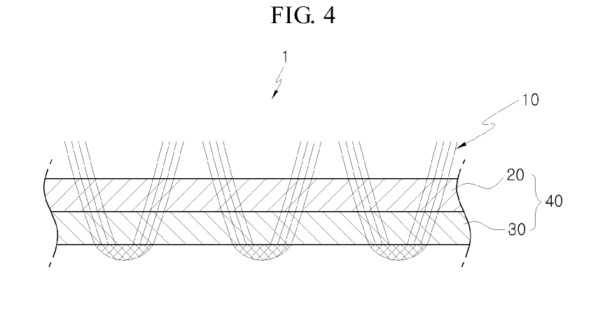

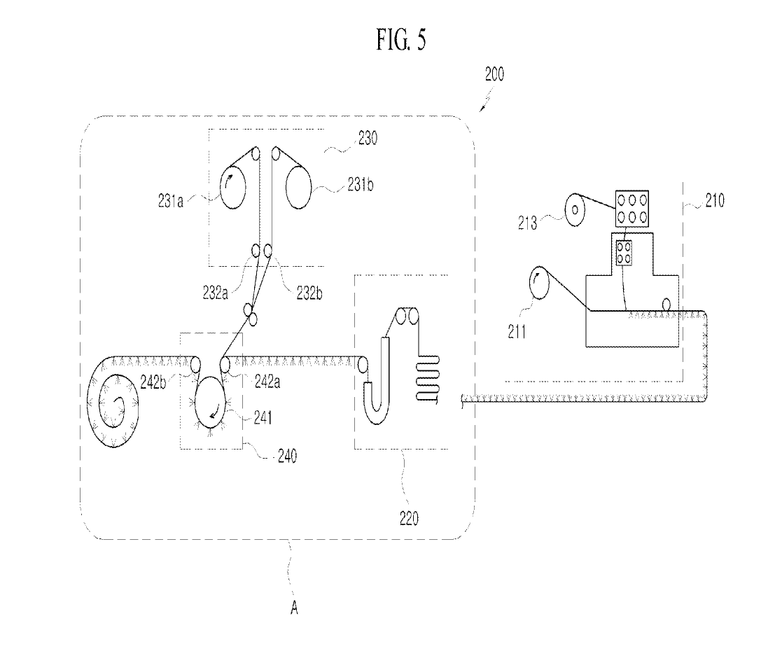

FIG. 3 shows pile yarns and backing fabrics not heat-fused to an artificial turf structure in accordance with an embodiment of the present invention. FIG. 4 is a cross-sectional view showing an artificial turf structure in accordance with an embodiment of the present invention.

Referring to FIGS. 3 and 4, in an artificial turf structure according to an embodiment of the present invention, pile yarns 10 are tufted to a plurality of backing fabrics. The plurality of backing fabrics includes a first backing fabric 20 and a second backing fabric under the first backing fabric 20. The pile yarns 10 penetrate the first backing fabric 20 and the second backing fabric 30 to be tufted, thereby forming an artificial turf to upper parts of the first backing fabric 20.

A part of the pile yarns 10 is exposed under the second backing fabric 30. In case that heat between 100° C. and 165° C. is applied, a part of the pile yarns is heat-fused to the second backing fabric 30. In this case, the first backing fabric 20 is not melted and maintained in a certain structure.

Since heat-fusing is performed between the second backing fabric 30 and the pile yarns 10, the pile yarns 10 can be strongly fixed.

That is, the pile yarns 10 can be strongly fixed without additional supporting layer such as latex coating layer. The manufacturing process of an artificial turf can be simplified.

Accordingly, an artificial turf structure 1 manufactured by the apparatus 100 includes a structure 40 including the first backing fabric 20 and the second backing fabric 30, and the pile yarns tufted on upper parts of the structure 40 to be partly exposed under the structure. The pile yarns 10 are compressed into the structure 40 by tension and the exposed pile yarns 10 by heat are heat-fused to the structure 40.

The pile yarns 10 is heat-fused to the structure 40 at a temperature of 140° C. to 180° C. The second backing fabric 20 and the pile yarns 10 are formed of the same material as polyolefin. The first backing fabric 20 is formed of polypropylene.

The correlation between the temperature at which the pile yarns of the artificial turf structure using the apparatus of FIG. 1 are heat-fused to the structure in accordance with the method of FIG. 2 and the tensile strength is measured. When the pile yarns are heat-fused to the second structure through the heating roller 131 of the heat-fusing unit, the heat-fusing temperatures were preset as a temperature of 100° C. to 140° C., a temperature of 140° C. to 180° C., and a temperature more 180° C. The tensile strengths of respective preset temperatures were measured. The tensile strength is measured in well-known apparatus and ways. The test result is shown as following table 1.

TABLE 1

| Temperature (° C.) | Tensile strength (kgf) |
|---|---|
| 100° C.-140° C. | Under 8.0 |
| 140° C.-180° C. | 8.0 to 10.0 |
| Excess 180° C. | Under 8.0 |

As can be seen from Table 1, when the heat-fusing was performed at the temperature of 100° C. to 140° C., the pile yarns were insufficiently melted. As a result, the pile yarns were not adhered to the structure. In this case, the tensile strength was less than 8.0.

Also, at the temperature more than 180° C., the pile yarns were shrunk (under 53 mm), and the artificial turf structure was shrunk (3%) in itself due to high temperature. The tensile strength was less than 8.0.

However, at the temperature of 140° C. to 180° C., the pile yarns was within normal range (55 mm), and the pile yarns were well heat-fused to the structure. The tensile strength of the artificial turf was within 8.0 to 10.0.

FIG. 5 is a schematic view showing an apparatus for manufacturing an artificial turf structure in accordance with another embodiment of the present invention.

Referring to FIG. 5, an apparatus for manufacturing an artificial turf 200 performs a function to manufacture an artificial turf structure formed of synthetic fabric. The shape of the artificial turf structure is maintained without coating latex. The manufacturing process of the artificial turf structure can be simplified. Also, the artificial turf structure is manufactured using a structure previously weaved in an embodiment of the present invention. In this case, the structure includes a backing fabric and pile yarns penetrating the backing fabric to be tufted.

According to another embodiment of the present invention, the backing fabric ad the pile yarns penetrating the backing fabric are tufted without using the previously manufactured structure to directly manufacture an artificial turf structure.

Also, the backing fabric is formed of woven fabric of polyolefin fabric or non-woven fabric of polyolefin fabric. Polyester staple fiber web or polyolefin staple fiber web may be formed under the woven fabric or the non-woven fabric.

The pile yarns are formed of polyolefin. For instance, the pile yarns may be formed of polyethylene, polypropylene, or poly-isobutylene.

In an embodiment of the present invention, the shape of the structure and pile yarns are fixed using the film formed of polyolefin. In particularly, the film is formed of polyolefin same as the pile yarns. In this case, when heat applies to the pile yarns and film, they are melted each other.

In the apparatus for manufacturing an artificial turf structure according to an embodiment of the present invention 200, the structure in which the pile yarns are tufted to the backing fabric and the film heat-fused to manufacture the artificial turf structure. The apparatus 200 includes a structure weaving unit 210, a structure providing unit 220, a film providing unit 230, and a heat-fusing unit 240. The structure weaving unit 210 may be included or not included. In case that the structure weaving unit 210 is not included, the artificial turf may be manufactured using the previously manufactured structure including the backing fabric and the pile yarns tufted to the backing fabric.

The structure weaving unit 210 is similar to the weaving unit 120 of the apparatus for manufacturing the artificial turf structure 100. The structure weaving unit 210 has a winding roller 213 and a fabric providing unit 211. There is a difference in that the structure weaving unit 210 weaves the structure by tufting the pile yarns to a single backing fabric, not the plurality of backing fabrics.

Accordingly, the structure weaving unit 210 has the same structure as the weaving unit 120 except for the compressing rollers 121a and 121b, and the description thereof will be omitted. The structure providing unit 220 is to provide the structure. The structure weaved by the structure weaving unit 210 is provided to the heat-fusing unit 240 by the structure providing unit 220. Therefore, the structure providing unit 220 may be included to provide the structure under the condition that the structure is stacked in a predetermined space or to provide the structure through rollers.

In an embodiment of the present invention, the structure providing unit 220 is formed in J-shaped box. Thus, lots of the structures can be stacked, and thereby minimizing used space.

The film providing unit 230 is to provide the structure and the film for fixing the pile yarns. The film is provided toward a back side of the structure provided from the structure providing unit 220. A plurality of film providing units 230 is included. In an embodiment of the present invention, two film rollers 231a and 231b and two guide rollers 232a and 23ab are included.

In this case, if there is no film remainder from one of the film roller 231a, the film of another film roller 231b can be used simultaneously, so that the manufacturing process of the artificial turf structure can be smoothly performed.

The film rollers 231a and 231b are formed by rolling the film. The rolled films are unwound to be provided. Thus, a conventional film roller can be employed.

The guide rollers 232a and 232b is to guide the film from the film rollers 231a and 231b to a heat-fusing unit 240 described later. The film unwound from the film rollers 231a and 231b dose not leave and is stably transferred. A plurality of guide rollers 232a and 232b may be included.

The heat-fusing unit 240 is to heat-fuse the structure and film. The film under the structure and the structure are heat-fused using heat. In this case, the structure and the film are compressed using tension in order that the film and the back side of the structure are heat-fused efficiently.

When the structure and the film are heat-fused in the heat-fusing unit 240, a part of the pile yarns penetrating the structure to be tufted is exposed under the structure. At this time, the pile yarns are heat-fused to the film. The tensile strength and durability of the pile yarns become more improved.

Also, the heat-fusing unit 240 is positioned at a rear end of the structure providing unit 220 and the film providing unit 230, and includes a heating roller 241 and tension rollers 242a and 242b.

The heating roller 241 is to apply heat to the film and may be included as a roller, which is heated at a predetermined temperature. The film is in contact with the circumference of the heating roller 241 to be heated. The heating roller 241 may apply heat to the film at a temperature of 140° C. to 180° C. If a temperature is lower than the above-mentioned temperature, the film is insufficiently melted so that the tensile strength of the artificial turf structure is low. In contrast, if a temperature is higher than the above-mentioned temperature, there are side effects such that the film is shrunk, and the artificial turf structure is shrunk in itself.

The circumference of the heating roller 241 is coated with non-adhesive agent including polytetrafluoroethylene (TEFLON) or epoxy resins in order that the film is not heat-fused or adhered.

The tension rollers 242a and 242b are to compress the film and the structure. A plurality of tension rollers 242a and 242b is included. The cylindrical column of the tension roller 242a and 242b is smaller than that of the heating roller 241 to be isolated from the heating roller 241 at a predetermined distance. The tension rollers 242a and 242b generate tension to the structure passing the heating roller 241 and the tension roller and the film.

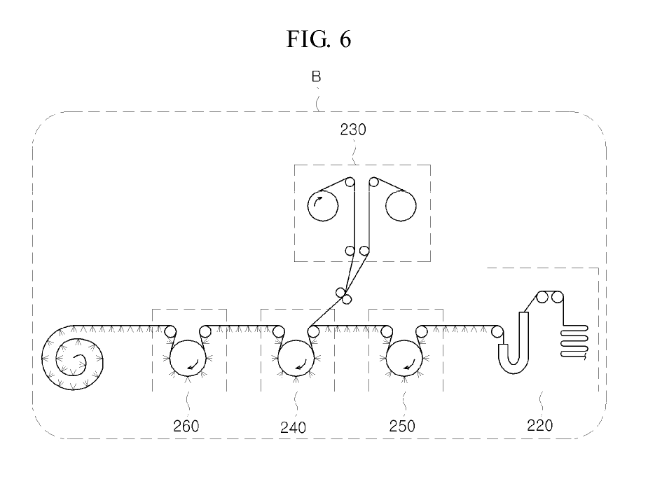

FIG. 6 is a schematic view showing the apparatus for manufacturing the artificial turf structure including a melting unit and a stabilizing unit. The (A) part of the apparatus for manufacturing the artificial turf structure of FIG. 5 may be replaced by the (B) part of FIG. 6.

Referring to FIG. 6, an apparatus for manufacturing an artificial turf according to an embodiment of the present invention 200 may further include a melting unit 250 for enhancing heat-fusing efficiency between the structure and the film, and a stabilizing unit for stabilizing the structure and the film.

The melting unit 250 is to melt the back side of the structure using heat. The melting unit 250 is positioned at a front end of the heat-fusing unit 240, before the structure and the film are heat-fused, to melt the back side of the structure, thereby improving heat-fusing efficiency between the film and the structure.

Also, the melting unit 250 may be formed using only a conventional heating roller 241. In an embodiment of the present invention, the melting unit 250 has substantially the same elements as the heat-fusing unit 240 mentioned above.

The stabilizing unit 260 is to stabilize the structure and the film heat-fused to the structure. The stabilizing unit 260 is positioned at a rear end of the heat-fusing unit 240 and applies heat to the structure and the film heat-fused to the structure, thereby improving property and stabilizing appearance.

The stabilizing unit 260 may include a heating roller using heat, a hot-air fan, and so forth. In an embodiment of the present invention, the stabilizing unit 260 has substantially the same elements as the heat-fusing unit 240 mentioned above.

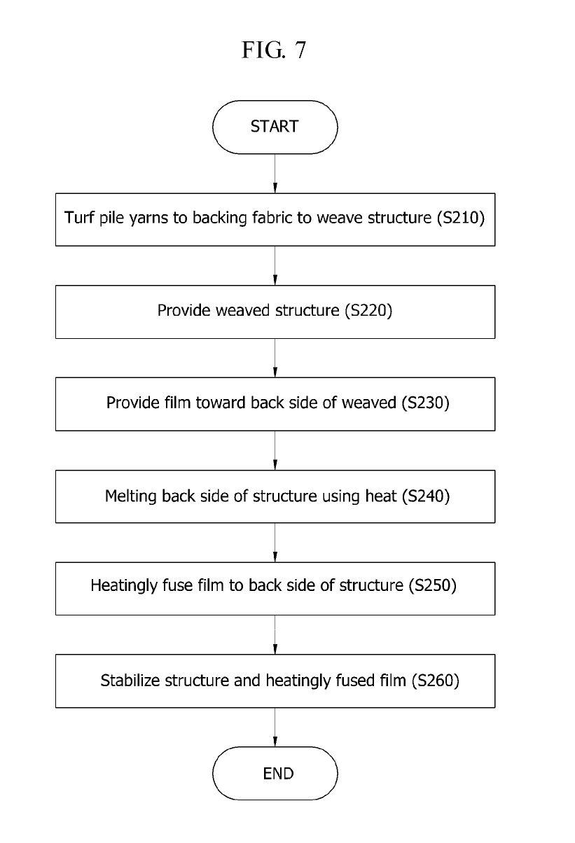

FIG. 7 is a flowchart illustrating a method for manufacturing an artificial turf structure in accordance with another embodiment of the present invention.

Referring to FIG. 7, in the method for manufacturing the artificial turf structure in accordance with another embodiment of the present invention, a structure is weaved by tufting pile yarns to a backing fabric (S210). The weaved structure is provided to the structure providing unit 220 (S220). The structure providing unit 220 provides the structure to the heat-fusing unit 240 (S230). The S210 can be omitted. The pre-weaved structure including the backing fabric and the pile yarns tufted to the backing yarn may be provided from the structure providing unit 220. Next, the film and the structure may be provided at the same time.

In addition, the film is provided toward the back side of the structure from the film providing unit 230. The back side of the structure is equivalent to opposite side of a side in which the pile yarns are tufted.

A plurality of film providing units 230 is included. Since the plurality of films is prepared, they are continuously provided in case that a fixed quantity of film is used (S230).

Next, the back side of the structure is melted using heat. The melting unit 250 applies heat to the back side of the structure. Also, since the pile yarns penetrate the backing fabric to be tufted, a part of the pile yarns exposed under the structure is melted simultaneously (S240).

Next, the film and the structure are heat-fused. At this time, the film is compressed under the structure, using tension generated from the tension rollers 242a and 242b of the heat-fusing unit 240. The film under the structure and the structure are heat-fused using heat generated from the heating roller 241 of the heat-fusing unit 240.

In case that the structure and the film are heat-fused, the pile yarns of the structure and the film have the same material as polyolefin so that the pile yarns and the film are melted each other, thereby improving tensile strength and durability as well as securing uniform property (S250).

To stabilize the structure and the film heat-fused to the structure, heat is applied to the structure passing the stabilizing unit 260 and the film heat-fused to the structure. The stabilizing unit 260 transfers heat to the back side of the film so that the film is strongly adhered to the back side of the structure to be stabilized.

In addition, heat is applied to the structure and the film heat-fused to the structure, thereby improving property and stabilizing appearance.

The artificial turf structure is manufactured through the stabilizing unit 260. The artificial turf structure may be wound using a conventional a winding roll.

In the artificial turf structure, the film is heat-fused to the back side of the backing fabric in which the pile yarns are tufted. The pile yarns and the film have the same material as polyolefin so that they are melted by heat to be heat-fused each other.

In other words, the pile yarns of the artificial turf structure are heat-fused to the film to be strongly fixed and can be maintained in a certain shape without additional latex coating. (S260).

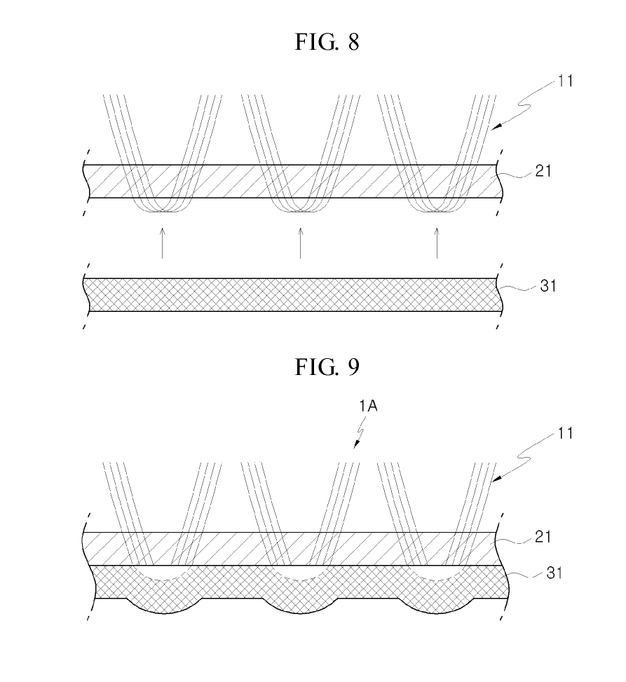

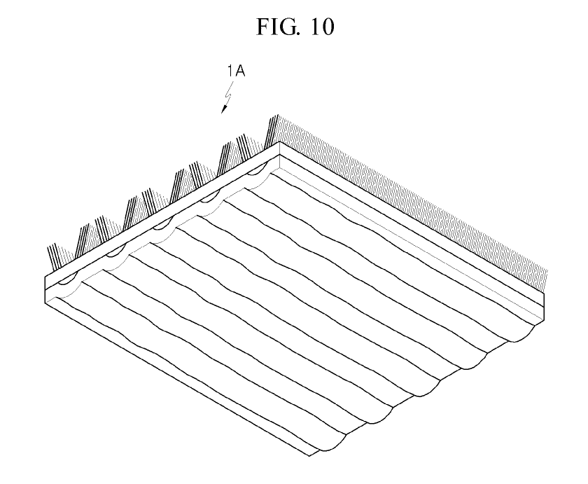

FIG. 8 is shows pile yarns, backing fabrics, and films which are not heat-fused to an artificial turf structure in accordance with another embodiment of the present invention. FIG. 9 is a cross-sectional view showing an artificial turf structure in accordance with another embodiment of the present invention. FIG. 10 is a bottom perspective view showing a backing side of an artificial turf structure in accordance with another embodiment of the present invention.

Referring to FIG. 8, an artificial turf structure according to an embodiment of the present invention includes a backing fabric 21 in which pile yarns 11 formed of polyolefin are tufted, and a film 31 formed of polyolefin to be heat-fused to a back side of the backing fabric 21.

The pile yarns 11 are formed to be artificial turf piles toward upper parts of the backing fabric 21. A part of the pile yarns 11 is exposed under the backing fabric 21.

The film 31 formed of polyolefin is heat-fused to the back side of the backing fabric 21, that is, an opposite side of a side in which the pile yarns 11 has an artificial turf shape.

Referring to FIGS. 9 and 10, in an artificial turf structure (1A), the film 31 is heat-fused under the backing fabric 21 in which the pile yarns 11 are tufted. In specifically, since the pile yarns 11 and the film 31 have the same material as polyolefin, they are heat-fused by heat in more efficiently.

Also, when a part of the pile yarns 11 exposed under the backing fabric 21 is melted by heat, the film 31 is also melted. At this time, the pile yarns 11 and the film 31 are heat-fused strongly.

In examining back sides of an artificial turf structure (1A) according to an embodiment of the present invention, a region where the pile yarns 11 is convexly protruded. This region is formed by melting a part of the pile yarns 11 and the films 31. In other words, the pile yarns 11 and film 31 are solidly combined by heat fusing.

Accordingly, the artificial turf structure (1A) manufactured by the apparatus of FIG. 5 according to the method of FIG. 7 includes a structure in which a part of the pile yarns is exposed under the backing fabric 21 by penetrating the backing fabric 21 to tuft the pile yarns 11, and a film positioned under the structure to fix the structure. In this case, the film 31 is compressed into the structure by tension and heat-fused to the structure by heat.

The pile yarns 11 and the film 31 of the structure may have the same material as polyolefin. The film 31 includes at least one selected from the group consisting of HDPE (High Density Polyethylene), LDPE (Low Density Polyethylene), and LLDPE (Liner Low Density Polyethylene). For example, both sides of the film have the same component or different component. For instance, one side of the film may be formed of LDPE (Low Density Polyethylene), and the other side of the film may be formed of HDPE (High Density Polyethylene). In this case, it is preferable that a surface in contact with the heating roller 241 is a film formed of HDPE (High Density Polyethylene). If a surface in contact with the heating roller 241 is a film formed of LDPE (Low Density Polyethylene), and/or LLDPE (Liner Low Density Polyethylene), the film may be heat-fused to the heating roller 241 by high temperature of the heating roller 241. If a surface in contact with the heating roller 241 is a film formed of HDPE (High Density Polyethylene), the film can be prevented from being heat-fused to the heating roller 241 so that excellent artificial turf structure can be manufactured.

The thickness of the film 31 is within a range of 80 μm to 500 μm. The film may further include a shrinkage prevention agent.

When an artificial turf structure is manufactured using a film added with shrinkage prevention agent, its shrinkage is 1.5% at a temperature of 60° C. for 30 days. This shrinkage is higher than 1.0% shrinkage of when shrinkage prevention agent is not added. The shrinkage prevention agent may include CaCO₃, for example.

The excellent durability of the artificial turf structure (1A) manufactured according to the present invention was tested. As a comparative example, instead of the film of the artificial turf structure (1A), latex is coated under the backing fabric in which the pile yarns are tufted.

The tensile strength was measured according to abrasion durability and submerging. After abrasion durability test was performed one hundred times (sliding on the ground more than one hundred times), the tensile strength from initial stage to ten times was measured by considering flood for three hours as one time.

The test result is shown as following table 2.

TABLE 2

| | | Artificial turf structure of | Comparative example |
|---|---|---|---|
| | | the present invention (1A) | (Latex coating) |
| Initial | | 8.23 | 10.52 |
| 1 | time | 8.31 | 7.16 |
| 2 | times | 8.4 | 7.02 |
| 3 | times | 8.48 | 5.9 |
| 4 | times | 9.04 | 6.9 |
| 5 | times | 8.6 | 6.1 |
| 6 | times | 8.8 | 6.43 |
| 7 | times | 8.31 | 5.92 |
| 8 | times | 8.69 | 5.63 |
| 9 | times | 9.15 | 5.77 |
| 10 | times | 9.31 | 5.79 |

As can be seen from Table 2, the artificial turf structure according to the present invention showed high tensile strength of 9.31 kgf even after abrasion durability test is performed one hundred times, and flood cycle test is performed ten times. The tensile strength of the artificial turf structure does not low below 8.0 from initial to ten times and indicates 8.0 and higher. In the comparative example, however, the artificial turf structure has high tensile strength at initial stage, but has low tensile strength of 5.79 kgf after abrasion durability test is performed one hundred times, and flood cycle test is performed ten times. Also, the artificial turf structure has low tensile strength under 6.9 kgf after three times of abrasion durability test and flood cycle test. It is confirmed that the tensile strength of the artificial turf structure is very low with respect to abrasion and flood.

As above mentioned, an artificial turf structure and a method for manufacturing the same according to an embodiment of the present invention, after tufting a first backing fabric formed of polypropylene and a second backing fabric formed of polyolefin by pile yarns formed of polyolefin, back sides of the second backing fabric are heat-fused using heat and tension to manufacture an artificial turf. As a result, an artificial turf structure only formed of synthetic fabric can be manufactured without latex. And, an artificial turf structure over use period can be recycled easily.

In addition, according to an artificial turf structure and a method for manufacturing the same according to an embodiment of the present invention, since the second backing fabric and the pile yarns exposed under the second backing fabric are heat-fused simultaneously, the pile yarns are strongly fixed without additional latex coating process, and the appearance stability and property are improved after manufacturing the artificial turf structure.

Also, according to an artificial turf structure and a method for manufacturing the same according to an embodiment of the present invention, after pile yarns are tufted to first and second backing fabrics, they are heat-fused to manufacture an artificial turf structure. Accordingly, a manufacturing process can be simplified to reduce manufacturing time and cost as well as to improve operation efficiency.

Also, according to an artificial turf structure and a method for manufacturing the same according to an embodiment of the present invention, a structure including pile yarns tufted to a backing fabric and a film for fixing an appearance of the structure and the pile yarns are formed of synthetic fabric, and the film is heat-fused through a heat-fusing unit. Thus, an artificial turf structure can be manufactured without coating additional latex. In particularly, the artificial turf structure is formed of only synthetic fabric to recycle all of them.

Additionally, according to an apparatus for manufacturing an artificial turf structure and a method for manufacturing the same according to an embodiment of the present invention, pile yarns formed of polyolefin and a film formed of the same material as the pile yarns are heat-fused, so that the pile yarns are strongly fixed, and the appearance stability of an artificial turf structure manufactured as a complete product can be enhanced.

Furthermore, according to an artificial turf structure and a method for manufacturing the same according to an embodiment of the present invention, a plurality of film providing units is included to prepare a plurality of film previously. Therefore, the film is continuously provided in manufacturing an artificial turf structure. Also, the artificial turf can be manufactured by heat-fusing the film on a back side of a structure where pile yarns are tufted to a backing fabric, thereby simplifying the manufacturing process.

As described above, the present invention provides an artificial turf structure has dramatically high tensile strength rather than an artificial turf structure coated with latex.

While this invention has been particularly shown and described with reference to an exemplary embodiment thereof, it will be understood by those skilled in the art that various changes in form and details may be made therein without departing from the spirit and scope of the invention as defined by the appended claims.

1-14. (canceled)

15. An artificial turf structure, comprising:
a structure including a first backing fabric and a second backing fabric; and
pile yarns tufted to an upper part of the structure and partly exposed under the structure, wherein the pile yarns are compressed into the structure and a part of the exposed pile yarns are heat-fused to the structure.

16. The artificial turf structure of claim 15, wherein the pile yarns are heat-fused to the structure at a temperature of 140° C. to 180° C.

17. The artificial turf structure of claim 15, wherein the second backing fabric and the pile yarns are formed of the same material as polyolefin.

18. The artificial turf structure of claim 15, wherein the first backing fabric is formed of polypropylene.

19-37. (canceled)
